(19) United States
(12) Patent Application Publication
(10) Pub. No.: US 2011/0221666 A1
(43) Pub. Date: Sep. 15, 2011

(54) Methods and Apparatus For Gesture Recognition Mode Control

(75) Inventors: John David Newton, Auckland (NZ); Stephen Sheng Xu, Auckland (NZ); Brendon Port, Auckland (NZ); Trent Smith, Auckland (NZ)

(73) Assignee: NOT YET ASSIGNED

(21) Appl. No.: 12/953,591

(22) Filed: Nov. 24, 2010

(30) Foreign Application Priority Data
Nov. 24, 2009 (AU) 2009905747

(51) Int. Cl. G06K 9/00

(52) U.S. Cl. 345/156

(57) ABSTRACT

Computing devices can comprise a processor and an imaging device. The processor can be configured to support both a mode where gestures are recognized and one or more other modes during which the computing device operates but does not recognize some or all available gestures. The processor can determine whether a gesture recognition mode is activated, use image data from the imaging device to identify a pattern of movement of an object in the space, and execute a command corresponding to the identified pattern of movement if the gesture recognition mode is activated. The processor can also be configured to enter or exit the gesture recognition mode based on various input events.

### PRIORITY CLAIM

This application claims priority to Australian Provisional Application No. 2009905747, filed Nov. 24, 2009 and titled “An apparatus and method for performing command movements in an imaging area,” which is incorporated by reference herein in its entirety.

### BACKGROUND

Touch-enabled computing devices continue to increase in popularity. For example, touch-sensitive surfaces that react to pressure by a finger or stylus may be used atop a display or in a separate input device. As another example, a resistive or capacitive layer may be used. As a further example, one or more imaging devices may be positioned on a display or input device and used to identify touched locations based on interference with light.

Regardless of the underlying technology, touch sensitive displays are typically used to receive input provided by pointing and touching, such as touching a button displayed in a graphical user interface. This may become inconvenient to users, who often need to reach toward a screen to perform a movement or command.

### SUMMARY

Embodiments include computing devices comprising a processor and an imaging device. The processor can be configured to support a mode where gestures in space are recognized, such as through the use of image processing to track the position, identity, and/or orientation of objects to recognize patterns of movement. To allow for reliable use of other types of input, the processor can further support one or more other modes during which the computing device operates but does not recognize some or all available gestures. In operation, the processor can determine whether a gesture recognition mode is activated, use image data from the imaging device to identify a pattern of movement of an object in the space, and execute a command corresponding to the identified pattern of movement if the gesture recognition mode is activated. The processor can also be configured to enter or exit the gesture recognition mode based on various input events.

This illustrative embodiment is discussed not to limit the present subject matter, but to provide a brief introduction. Additional embodiments include computer-readable media embodying an application configured in accordance with aspects of the present subject matter and computer-implemented methods configured in accordance with the present subject matter. These and other embodiments are described below in the Detailed Description. Objects and advantages of the present subject matter can be determined upon review of the specification and/or practice of an embodiment configured in accordance with one or more aspects taught herein.

### BRIEF DESCRIPTION OF THE DRAWINGS

FIG. 1 is a diagram showing an illustrative computing system configured to support gesture recognition.

FIGS. 2 and 3 are each an example of interacting with a computing system that supports gesture recognition.

FIG. 4 is a flowchart showing illustrative steps of a method of gesture recognition.

FIG. 5 is a flowchart showing an example of detecting when a gesture command mode is to be entered.

FIGS. 6A-6E are diagrams showing examples of entering a gesture command mode and providing a gesture command.

FIGS. 7A-7D are diagrams showing another illustrative gesture command.

FIGS. 8A-8C and 9A-9C each show another illustrative gesture command.

FIGS. 10A-10B show another illustrative gesture command.

FIGS. 11A-11B show illustrative diagonal gesture commands.

FIGS. 12A-12B show a further illustrative gesture command.

### DETAILED DESCRIPTION

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment.

In the following detailed description, numerous specific details are set forth to provide a thorough understanding of the subject matter. However, it will be understood by those skilled in the art that the subject matter may be practiced without these specific details. In other instances, methods, apparatuses or systems that would be known by one of ordinary skill have not been described in detail so as not to obscure the subject matter.

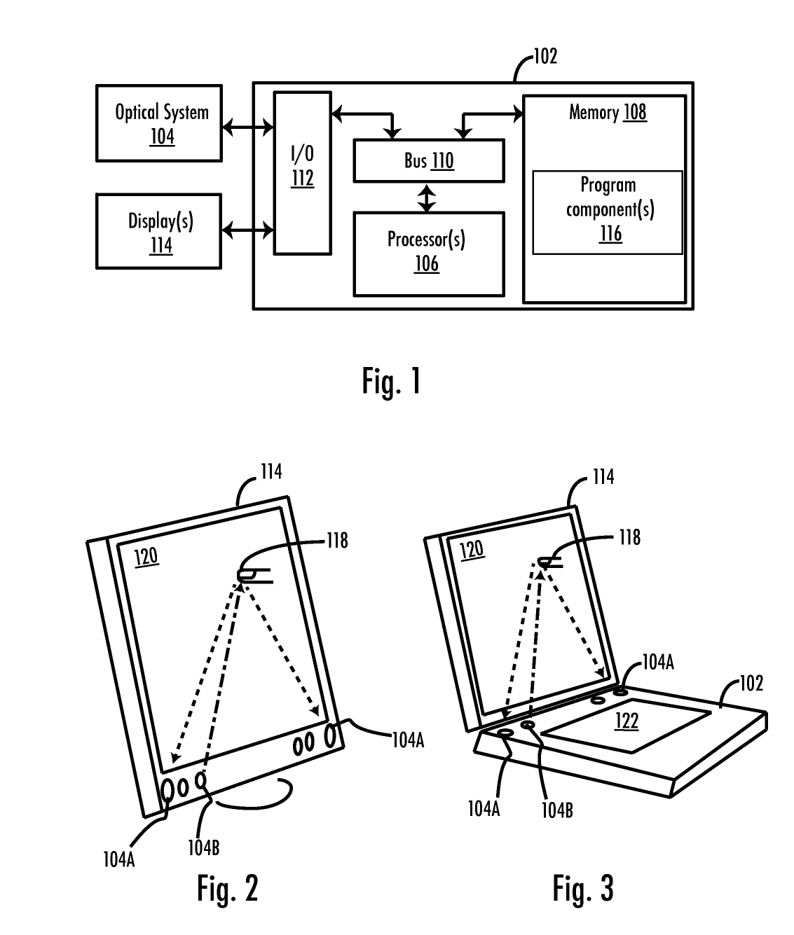

FIG. 1 is a diagram showing an illustrative computing system 102 configured to support gesture recognition. Computing device 102 represents a desktop, laptop, tablet, or any other computing system. Other examples include, but are not limited to, mobile devices (PDAs, smartphones, media players, gaming systems, etc.) and embedded systems (e.g., in vehicles, appliances, kiosks, or other devices).

In this example, system 102 features an optical system 104, which can include one or more imaging devices such as line scan cameras or area sensors. Optical system 104 may also include an illumination system, such as infrared (IR) or other source or sources. System 102 also includes one or more processors 106 connected to memory 108 via one or more busses, interconnects, and/or other internal hardware indicated at 110. Memory 108 represents a computer-readable medium such as RAM, ROM, or other memory.

I/O component(s) 112 represents hardware that facilitates connections to external resources. For example, the connections can be made via universal serial bus (USB), VGA, HDMI, serial, and other I/O connections to other computing hardware and/or other computing devices. It will be understood that computing device 102 could include other components, such as storage devices, communications devices (e.g., Ethernet, radio components for cellular communications, wireless internet, Bluetooth, etc.), and other I/O components such as speakers, a microphone, or the like. Display(s) 114 represent any suitable display technology, such as liquid crystal diode (LCD), light emitting diode (LED, e.g., OLED), plasma, or some other display technology.

Program component(s) 116 are embodied in memory 108 and configure computing device 102 via program code executed by processor 106. The program code includes code that configures processor 106 to determine whether a gesture recognition mode is activated, use image data from the imaging device(s) of optical system 104 to identify a pattern of movement of an object in the space, and program code that configures processor 106 to execute a command corresponding to the identified pattern of movement if the gesture recognition mode is activated.

For example, component(s) 116 may be included in a device driver, a library used by an operating system, or in another application. Although examples are provided below, any suitable input gestures can be recognized, with a “gesture” referring to a pattern of movement through space. The gesture may include touch or contact with display 114, a keyboard, or some other surface, or may occur entirely in free space.

FIGS. 2 and 3 are each an example of interacting with a computing system that supports gesture recognition. In FIG. 2, display 114 is implemented as a standalone display connected to or comprising device 102 (not shown here). An object 118 (a user's finger in this example) is positioned proximate a surface 120 of display 114. In FIG. 3, display 114 is included as part of a laptop or netbook computer 102 featuring keyboard 122; other examples of input devices include mice, trackpads, joysticks, and the like.

As shown by the dashed lines, light from object 118 can be detected by one or more imaging devices 104A based on light emitted from source 104B. Although a separate light source is shown in these examples, some implementations rely on ambient light, or even light emitted from a source on object 118. Object 118 can be moved in the space adjacent display 114 and in view of imaging devices 104A in order to set zoom levels, scroll pages, resize objects, and delete, insert, or otherwise manipulate text and other content, for example. Gestures may involve movement of multiple objects 118—for example, pinches, rotations, and other movements of fingers (or other objects) relative to one another.

Because use of computing device 102 will likely entail contact-based input or other non-gesture input, the support of at least a gesture input mode when gestures are recognized and at least one second mode during which some or all gestures are not recognized is advantageous. For example, in the second mode, optical system 104 can be used to determine touch or near-touch events with respect to surface 120. As another example, when the gesture recognition mode is not active, optical system 104 could be used to identify contact-based inputs, such as keyboard inputs determined based on contact locations in addition to or instead of actuation of hardware keys. As a further example, when gesture recognition mode is not active, device 102 could continue operating using hardware-based input.

In some implementations, the gesture recognition mode is activated or deactivated based on one or more hardware inputs, such as actuation of a button or a switch. For example, a key or key combination from keyboard 122 can be used to enter and exit gesture recognition mode. As another example, software input indicating that the gesture recognition mode is to be activated can be used—for example, an event can be received from an application indicating that the gesture recognition mode is to be activated. The event may vary on the application—for instance, a configuration change in the application may enable gesture inputs and/or the application may switch into gesture recognition mode in response to other events. However, in some implementations gesture recognition mode is activated and/or deactivated based on recognizing a pattern of movement.

For example, returning to FIG. 1, program component(s) 116 can include program code that configures processor 106 to analyze data from the imaging device to determine whether an object is in the space for a threshold period of time and, if the object is in the space for the threshold period of time, store data indicating that the gesture recognition mode is activated. The code may configure processor 106 to search the image data for the object at a particular portion of the space and/or to determine if the object is present without the presence of other factors (e.g., without the presence of movement).

As a particular example, the code may configure processor 106 to search the image data for a finger or another object 118 and, if the finger/object remains stationary in the image data for a set period of time, to activate gesture recognition capabilities. For instance, a user may type on keyboard 122 and then lift a finger and hold it in place to activate gesture recognition capability. As another example, the code may configure processor 106 to search image data to identify a finger proximate surface 120 of screen 114 and, if the finger is proximate to surface 120, to switch into gesture recognition mode.

As noted above, gestures may be used to deactivate the gesture recognition mode as well. For example, one or more patterns of movement may correspond to a deactivation pattern. Executing the command can comprise storing data that the gesture recognition mode is no longer activated. For example, a user may trace a path corresponding to an alphanumeric character or along some other path that is recognized and then a flag set in memory to indicate that no further gestures are to be recognized until the gesture recognition mode is again activated.

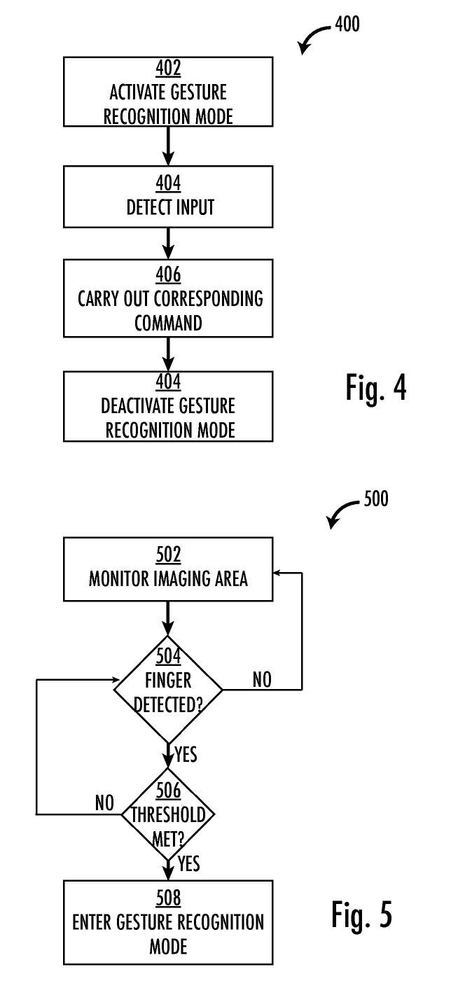

FIG. 4 is a flowchart showing illustrative steps of a method 400 of gesture recognition. For example, method 400 may be carried out by a computing device configured to operate in at least a gesture recognition mode and a second mode during which some or all gestures are not recognized. In the second mode (or modes), hardware input may be received and/or touch input may be received. The same hardware used for gesture recognition may be active during the second mode(s) or may be inactive except when the gesture recognition mode is active.

Block 402 represents activating the gesture recognition mode in response to a user event indicating that the gesture recognition mode is to be activated. The event may be hardware-based, such as input from a key press, key combination, or even a dedicated switch. As also noted above, the event may be software based. As another example, one or more touch-based input commands may be recognized, such as touches at portions of a display or elsewhere on the device that correspond to activating the gesture recognition mode. As a further example, the event may be based on image data using the imaging hardware used to recognize gestures and/or other imaging hardware.

For example, as noted below, presence of an object beyond a threshold period of time in the imaged space can trigger the gesture recognition mode. As another example, prior to activation of the gesture recognition mode, the system may be configured to recognize a limited subset of one or more gestures that activate the full gesture recognition mode, but not to respond to other gestures until the gesture recognition mode is activated.

Block 404 represents detecting input once the gesture recognition mode is activated. For example, one or more imaging devices can be used to obtain image data representing a space, such as a space adjacent a display, above a keyboard, or elsewhere, with image processing techniques used to identify one or more objects and motion thereof. For example, in some implementations, two imaging devices can be used along with data representing the relative position of the devices to the imaged space. Based on a projection of points from imaging device coordinates, one or more space coordinates of object(s) in the space can be detected. By obtaining multiple images over time, the coordinates can be used to identify a pattern of movement of the object(s) in the space. The coordinates may be used to identify the object as well, such as by using shape recognition algorithms.

The pattern of movement can correspond to a gesture. For example, a series of coordinates of the object can be analyzed according to one or more heuristics to identify a likely intended gesture. For example, when a likely intended gesture is identified, a dataset correlating gestures to commands can be accessed to select a command that corresponds to the gesture. Then, the command can be carried out, and block 406 represents carrying out that command, either directly by the application analyzing the input or by another application that receives data identifying the command. Several examples of gestures and corresponding commands are set forth later below.

In some implementations, identifying the pattern of movement of the object comprises identifying a first pattern of movement followed by a second pattern of movement. In such a case, determining the command to be carried out can comprise selecting one of a plurality of commands based on the first pattern of movement and determining a parameter value based on the second pattern of movement. For example, a first gesture can be used to determine a zoom command is desired and a second gesture can be used to determine the desired degree of zoom and/or direction (i.e., zoom-in or zoom-out). Numerous patterns of movement may be chained together (e.g., a first pattern of movement, second pattern of movement, third pattern of movement, etc.).

Block 408 represents deactivating the gesture recognition mode in response to any desired input event. For example, actuation of a hardware element (e.g., a key or switch) may deactivate the gesture recognition mode. As another example, the dataset of commands may include one or more “deactivation” gestures that correspond to a command to exit/deactivate the gesture recognition mode. As a further example, the event may simply comprise absence of a gesture for a threshold period of time, or absence of the object from the imaged space for a threshold period of time.

FIG. 5 is a flowchart showing steps in an example method 500 of detecting when a gesture command mode is to be entered. For example, a computing device may carry out method 500 prior to performing gesture recognition, such as one or more of the gesture recognition implementations noted above with respect to FIG. 4.

Block 502 represents monitoring the area imaged by the optical system of the computing device. As mentioned above, one or more imaging devices can be sampled and the resulting image data representing the space can be analyzed for the presence or absence of one or more objects of interest. In this example, a finger is the object of interest, and so block 504 represents evaluating whether a finger is detected. Other objects, of course, could be searched for in addition to or instead of a finger.

Block 506 represents determining whether the object of interest (e.g., the finger) is in the space for a threshold period of time. As shown in FIG. 5, if the threshold period of time has not passed, the method returns to block 504 where, if the finger remains detected, the method continues to wait until the threshold is met or the finger disappears from view. However, if at block 506 the threshold is met and the object remains in view for the threshold period of time, then the gesture recognition mode is entered at block 508. For example, process 400 shown in FIG. 4 could be carried out, or some other gesture recognition process could be initiated.

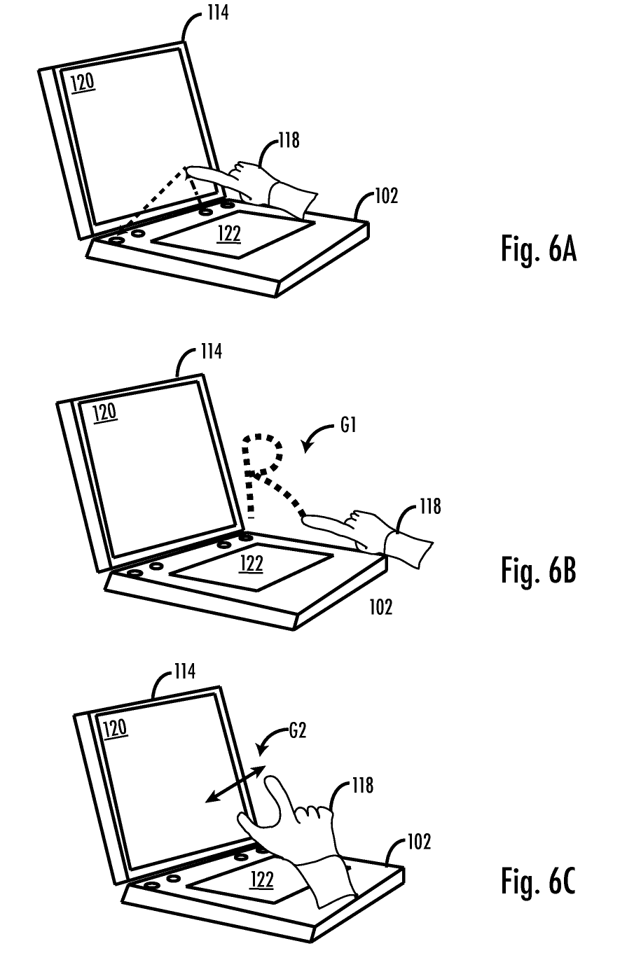

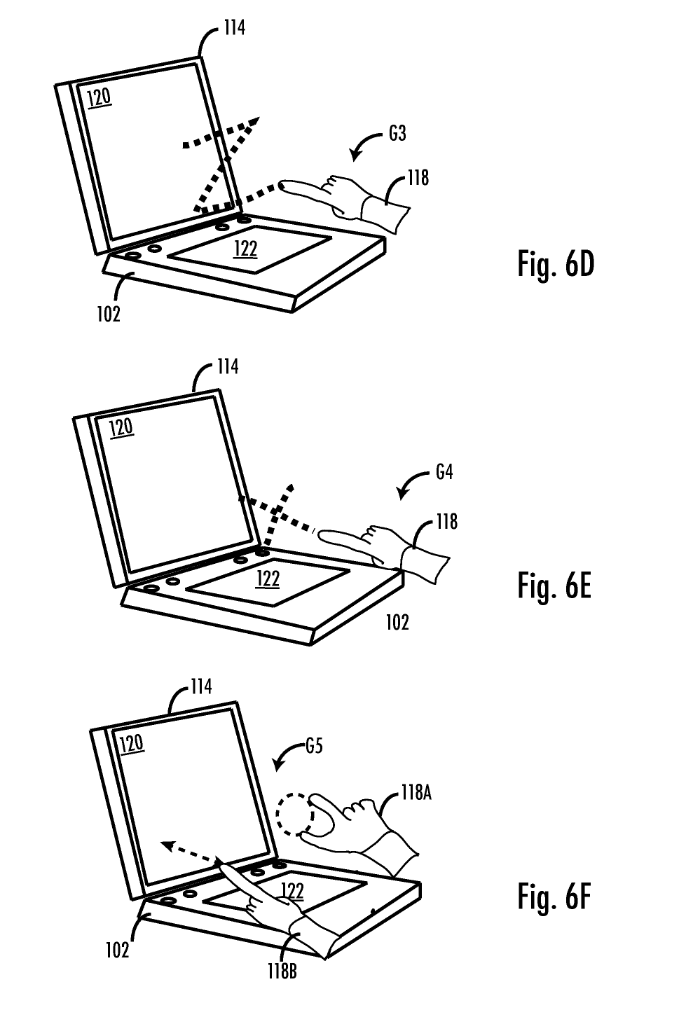

FIGS. 6A-6E are diagrams showing an example of entering a gesture command mode and then providing a gesture command. These examples depict the laptop form factor of device 102, but of course any suitable device could be used. In FIG. 6A, object 118 is a user's hand and is positioned in the space imaged by device 102. By holding a finger in view for a threshold period of time (e.g., 1-5 seconds), the gesture recognition mode can be activated.

In FIG. 6B, the user is providing a command by tracing a first pattern as shown at G1. In this example, the pattern of movement corresponds to an alphanumeric character—the user has traced a path corresponding to an “R” character. This gesture could, in and of itself, be used to provide a command. However, as noted above, commands can be specified by two (or more) gestures. For example, the “R” character can be used to select a command type (e.g., “resize,”) with a second gesture to indicate the desired degree of resizing.

For example, in FIG. 6C, a second gesture is provided as shown by the arrow at G2. In particular, the user provides a pinching gesture that is used by computing device 102 to determine the degree of resizing after the “R” gesture has been recognized. In this example, a pinching gesture is provided, but other gestures could be used. For example, a user could move two fingers towards or away from one another instead of making the pinching gesture.

As another example, the flow could proceed from FIG. 6A to FIG. 6C. In particular, after the gesture recognition mode is entered in FIG. 6A, the pinching gesture of FIG. 6C could be provided to implement a zoom command or some other command directly.

FIG. 6D shows another example of a gesture. In this example, the pattern of movement corresponds to a “Z” character as shown at G3. For instance, the corresponding command can comprise a zoom command. The amount of zoom could be determined based on a second gesture, such as a pinch gesture, a rotational gesture, or a gesture along a line towards or away from the screen.

In FIG. 6E, as shown at G4 the pattern of movement corresponds to an “X” character. The corresponding command can be to delete a selected item. The item to be deleted can be specified before or after the gesture.

FIG. 6F shows an example of providing two simultaneous gestures G5 and G6 by objects 118A and 118B (e.g., a user's hands). The simultaneous gestures can be used to rotate (e.g., the circular gesture at G5) and to zoom (e.g., the line pointed toward display 114).

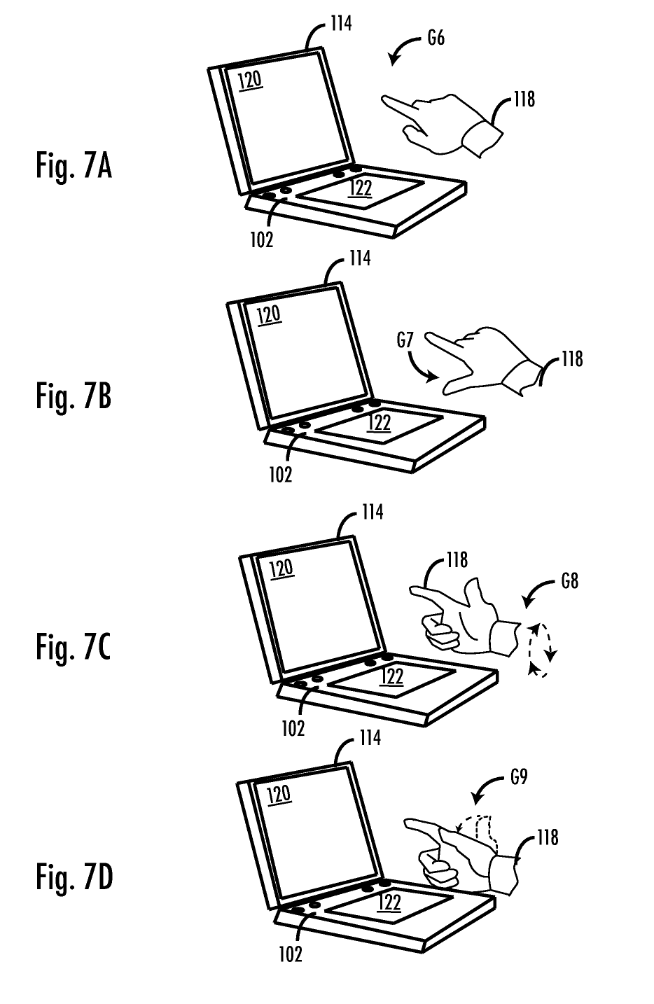

FIGS. 7A-7D are diagrams showing another illustrative gesture command. As shown in FIG. 7A, object 118 may begin from a regular pointing position as shown at G6. The gesture that is recognized can correspond to a “shooting” command made using a finger and thumb. For example, as shown at G7 in FIG. 7B the user can begin by stretching a thumb away from his or her hand.

Optionally, the user can then rotate his or her hand as shown at G8 in FIG. 7C. The user can complete his/her gesture as shown at G9 in FIG. 7D by bringing his/her thumb back into contact with the rest of his/her hand. For example, the gesture may correlate to a command such as shutting down an application or closing an active document, with the application/document indicated by the pointing gesture or through some other selection. However, the gesture can be used for another purpose (e.g., deleting a selected item, ending a communications session, etc.).

In some implementations, the rotational portion of the gesture shown at G8 need not be performed. Namely, the user can extend the thumb as shown at G7 and then complete a “sideways shooting” gesture by bringing his/her thumb into contact with the remainder of his/her hand.

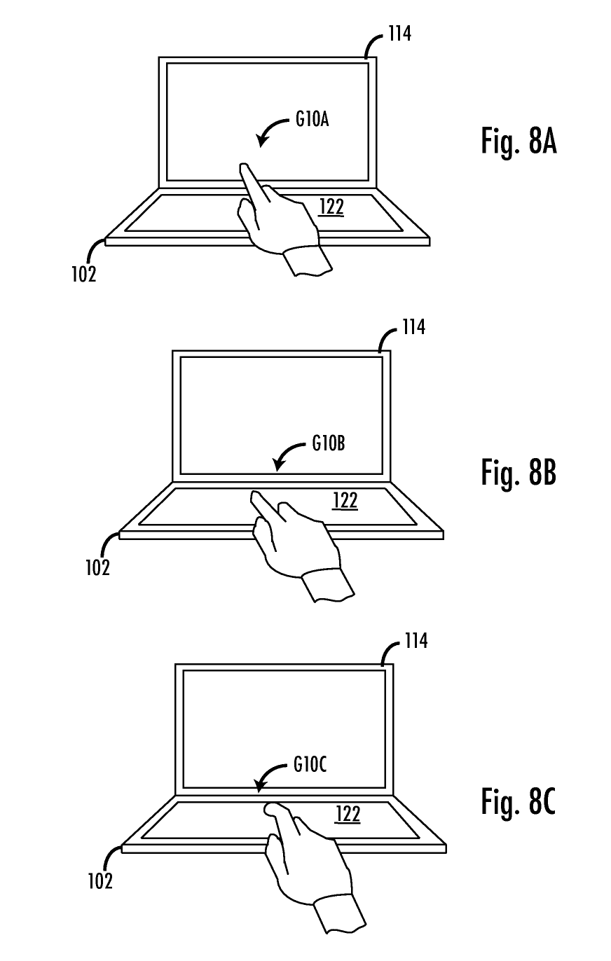

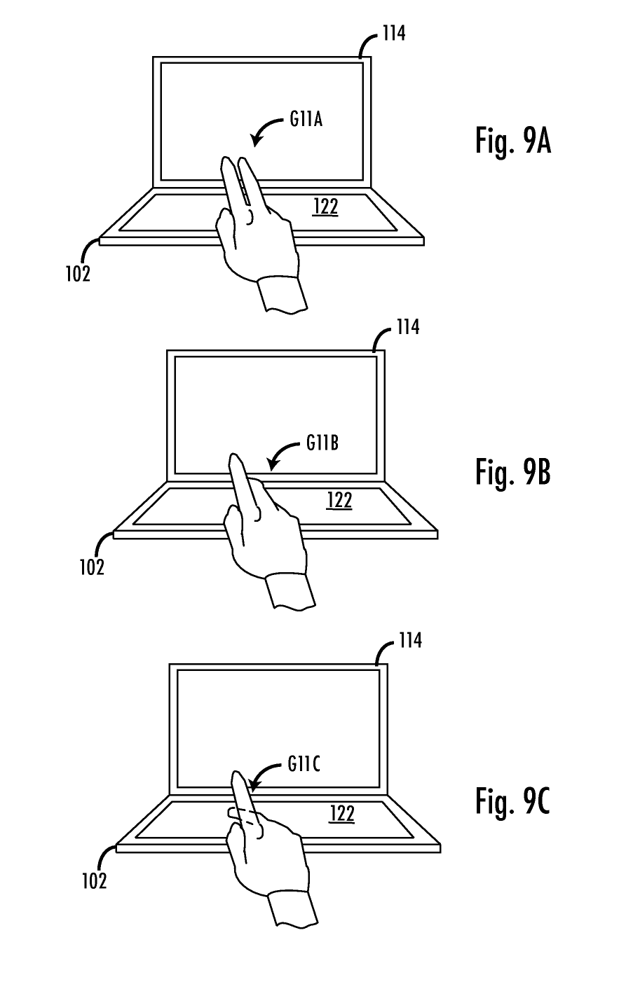

FIGS. 8A-8C and 9A-9C each show another illustrative type of gesture command, specifically single-finger click gestures. FIGS. 8A-8C show a first use of the single-finger click gesture. Gesture recognition systems may recognize any number of gestures for performing basic actions, such as selection (e.g., clicks). However, frequently-used gestures should be selected to minimize muscle fatigue.

FIG. 8A shows an initial gesture G10A during which a user moves a cursor by pointing, moving an index finger. etc. As shown at G10B-G10C in FIGS. 8B and 8C, the user can perform a selection action by making a slight incurvation of his or her index finger. Of course, another finger other than the index finger could be recognized for this gesture.

In some instances, the single-finger click gesture can cause difficulty, particularly if the gesture recognition system uses a finger to control cursor position. Accordingly, FIGS. 9A-9C show another illustrative gesture command used for selection action. In this example, motion of a second finger alongside the pointing finger is used for the selection action.

As shown in FIG. 9A, the gesture may be recognized starting from two extended fingers as shown at G11A. For example, a user may point using an index finger and then extend a second finger, or may point using two fingers. The selection action can be indicated by an incurvation of the second finger. This is shown at G11B-G11C in FIGS. 9B and 9C. Particularly, as shown by the dashed lines in FIG. 9C, the user's second finger is curved downward while the index finger remains extended. In response to the second finger movement, the selection action (e.g., a click) can be recognized.

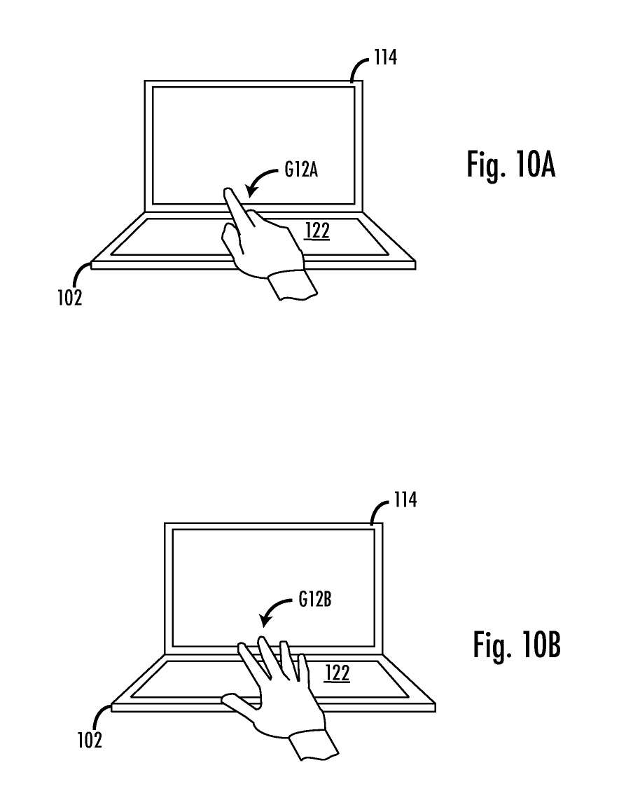

FIGS. 10A-10B show another illustrative gesture. For example, an operating system may support a command to display a desktop, clear windows from the display area, minimize windows, or otherwise clear the display area. The gesture shown in FIGS. 10A-B may be used to invoke such a command, or another command. As shown at G12A in FIG. 10A, the user may begin from a regular pointing gesture. When the user desires to invoke the show desktop (or other command), the user can extend his or her fingers as shown at G12B in FIG. 10B so that the user's fingers are separated. The gesture recognition system can identify that the user's fingers have extended/separated and, if all fingertips are separated by a threshold distance, the command can be invoked.

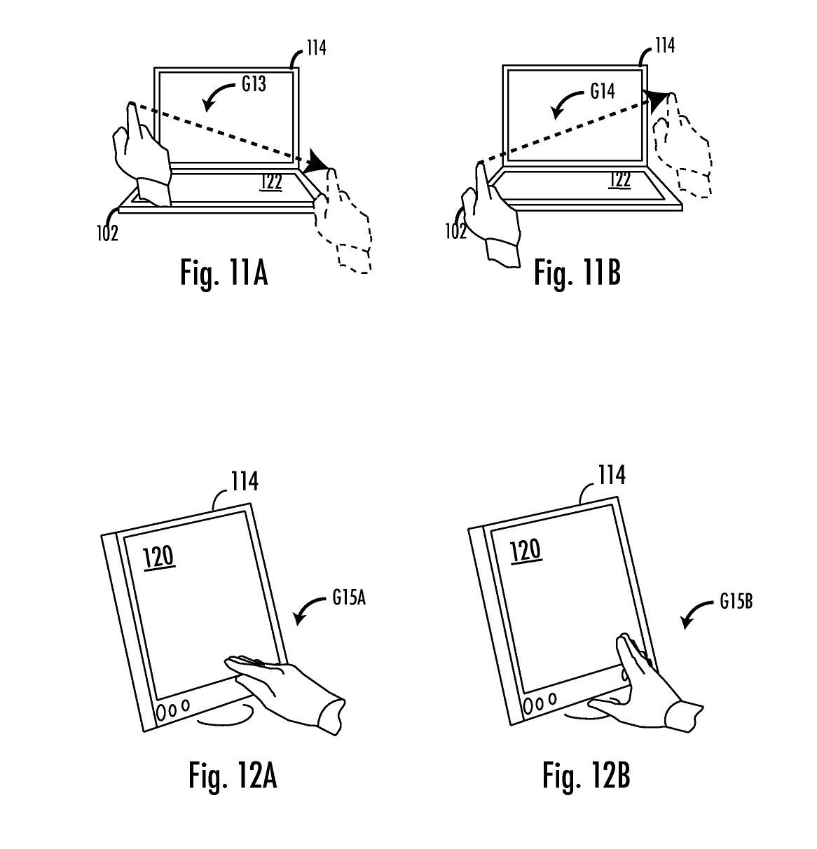

FIGS. 11A-11B show illustrative diagonal gesture commands. For example, as shown at G13 in FIG. 11A, a user may trace a diagonal path from the upper left to lower right portion of the imaged space, or the user may trace a diagonal path as shown at G14 from the lower left to upper right. One direction (e.g., the gesture G13) may correspond to a resize operation to grow an image, while the other (e.g., G14) may correspond to a reduction in size of the image. Of course, other diagonal gestures (e.g., upper right to lower left, lower right to upper left) can be mapped to other resizing commands.

FIGS. 12A-12B show a further illustrative gesture command. As shown at G15A in FIG. 12A, a user can begin with a closed hand, and then as shown in FIG. 12B at G15B, the user can open his or her hand. The gesture recognition system can identify, for example, the motion of the user's fingertips and distance between the fingertips and thumb in order to determine when the user has opened his or her hand. In response, the system can invoke a command, such as opening a menu or document. In some implementations, the number of fingers raised during the gesture can be used to determine which of a plurality of menus is opened, with each finger (or number of fingers) corresponding to a different menu.

Another example of a gesture is a knob-rotation gesture in which a plurality of fingers are arranged as if gripping a knob. For example, the gesture recognition can recognize placement of two fingers as if the user is gripping a knob or dial, followed by rotation of the user's hand such as shown at 118A in FIG. 6F. The user can continue the gesture by moving one finger in the same overall circle to continue the gesture. The gesture can be recognized from the circular pattern of fingertip locations followed by tracking the remaining finger as the gesture is continued. The gesture can be used to set volume control, select a function or item, or for some other purpose. Additionally, a z-axis movement along the axis of rotation (e.g., toward or away from the screen) can be used for zoom or other functionality.

Yet another example of a gesture is a flat hand panning gesture. For example, a user may place an open and in view of the gesture recognition system and move the hand left, right, up, or down to move an object, pan an onscreen image, or invoke another command.

A further gesture is a closed-hand rotation gesture. For example, a user may close a fist and then rotate the closed fist. This gesture can be recognized, for example, by tracking the orientation of the user's fingers and/or by recognizing the closed fist or closing of the hand, followed by rotation thereof. The closed fist gesture can be used, for example, in 3D modeling software to rotate an object about an axis.

Other gestures can be defined, of course. As another example, a pattern of movement may correspond to a line in space, such as tracing a line parallel to an edge of the display to provide a vertical or horizontal scroll command. As another example, a line in the space can extend toward the display or another device component, with the corresponding command being a zoom command.

Although specific examples were noted above for the “R”, “Z”, and “X” alphanumeric characters, the path could correspond to any alphanumeric character in any language. In some implementations, the path traced by the alphanumeric gesture is stored in memory and then a character recognition process is performed to identify the character (i.e., in a manner similar to optical character recognition, though in this case rather than pixels defined on a page, the character's pixels are defined by the gesture path). Then, an appropriate command can be determined from the character. For example, computer applications can be indexed to various letters (e.g., “N” for Notepad.exe, “W” for Microsoft(R) Word(R), etc.). Recognition of alphanumeric gestures could also be used to sort lists, select items from a menu, etc.

As another example, the path could correspond to some other shape, such as a polygon, circle, or an arbitrary shape or pattern. The system may identify a corresponding character, pattern, or shape in any suitable manner. Additionally, in identifying any gesture, the system can allow for variations in the path (e.g., to accommodate imprecise motion by users).

Any one of the gestures discussed herein can be recognized alone by a gesture recognition system, or may be recognized as part of a suite of gestures, the suite of gestures including any one or more of the others discussed herein, and/or still further gestures. Additionally, the gestures presented in the examples above were presented with examples of commands. One of skill in the art will recognize that that particular pairings of gestures and commands are for purposes of example only, and that any gesture or pattern of movement described herein can be used as part of another gesture, and/or may be correlated to any one of the commands described herein or to one or more other commands.

### General Considerations

The various systems discussed herein are not limited to any particular computing hardware architecture or configuration. A computing device can include any suitable arrangement of components that provide a result conditioned on one or more inputs.

Suitable computing devices include microprocessor-based computer systems accessing stored software from a non-transitory computer-readable medium (or media), the software comprising instructions that program or configure the general-purpose computing apparatus to act as a specialized computing apparatus implementing one or more embodiments of the present subject matter. Any suitable programming, scripting, or other type of language or combinations of languages may be used to implement the teachings contained herein in software to be used in programming or configuring a computing device. When software is utilized, the software may comprise one or more components, processes, and/or applications. Additionally or alternatively to software, the computing device(s) may comprise circuitry that renders the device(s) operative to implement one or more of the methods of the present subject matter. For example, an application-specific integrated circuit (ASIC) or programmable logic array may be used.

Examples of computing devices include, but are not limited to, servers, personal computers, mobile devices (e.g., tablets, smartphones, personal digital assistants (PDAs), etc.) televisions, television set-top boxes, portable music players, and consumer electronic devices such as cameras, camcorders, and mobile devices. Computing devices may be integrated into other devices, e.g. “smart” appliances, automobiles, kiosks, and the like.

Embodiments of the methods disclosed herein may be performed in the operation of computing devices. The order of the blocks presented in the examples above can be varied—for example, blocks can be re-ordered, combined, and/or broken into sub-blocks. Certain blocks or processes can be performed in parallel.

Any suitable non-transitory computer-readable medium or media may be used to implement or practice the presently-disclosed subject matter, including, but not limited to, diskettes, drives, magnetic-based storage media, optical storage media (e.g., CD-ROMS, DVD-ROMS, and variants thereof), flash, RAM, ROM, and other memory devices, along with programmable logic as noted above.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

What is claimed:

1. A computer-implemented method, comprising:
receiving input indicating that a gesture recognition mode of a computing device is to be activated, the computing device configured to operate in at least a gesture recognition mode and a second mode during which gestures are not recognized;
in response to the received input, activating the gesture recognition mode, and while the gesture recognition mode is activated:
obtaining image data representing a space,
identifying a pattern of movement of an object in the space based on the image data,
determining a command to be carried out by the computing device and corresponding to the pattern of movement, and
carrying out the command.

2. The method of claim 1, wherein receiving input indicating that the gesture recognition mode is to be activated comprises:
obtaining image data representing the space, and
analyzing the image data to determine whether the object is in the space for a threshold period of time, wherein the gesture recognition mode is to be activated if the object remains in view for the threshold period of time.

3. The method of claim 2, wherein analyzing the image data comprises determining whether a finger is in the space for the threshold period of time.

4. The method of claim 1, wherein receiving input indicating that the gesture recognition mode is to be activated comprises:
sensing actuation of a button or switch.

5. The method of claim 1, wherein receiving input indicating that the gesture recognition mode is to be activated comprises receiving input indicating that a key or combination of keys of a keyboard has been pressed.

6. The method of claim 1, wherein receiving input indicating that the gesture recognition mode is to be activated comprises receiving an event from a software application indicating that the gesture recognition mode is to be activated.

7. The method of claim 1, wherein identifying the pattern of movement of the object in the space comprises identifying a deactivation pattern, the command is a command to exit the gesture recognition mode, and wherein carrying out the command is exiting the gesture recognition mode.

8. The method of claim 1,
wherein identifying the pattern of movement of the object comprises identifying a first pattern of movement followed by a second pattern of movement, and
wherein determining the command to be carried out comprises selecting one of a plurality of commands corresponding to the first pattern of movement and determining a parameter value based on the second pattern of movement.

9. The method of claim 1, wherein the pattern of movement corresponds to a line in the space and the command comprises a scroll command.

10. The method of claim 1, wherein the pattern of movement corresponds to a line in the space pointed toward a display device and the command comprises a zoom command.

11. The method of claim 1, wherein the pattern of movement comprises a path in space corresponding to an alphanumeric character.

12. The method of claim 11, wherein the pattern of movement corresponds to a “Z” character and the command comprises a zoom command.

13. The method of claim 11, wherein the pattern of movement corresponds to a “R” character and the command comprises a resize command.

14. The method of claim 11, wherein the pattern of movement corresponds to a “X” character and the command comprises a delete command.

15. The method of claim 1, wherein the pattern of movement comprises a shooting gesture recognized by a pointing gesture followed by extension of a thumb from a user's hand, followed by bringing the thumb back into contact with the hand.

16. The method of claim 1, wherein the pattern of movement comprises a single-click gesture recognized by an incurvation of a user's finger.

17. The method of claim 16, wherein the single-click gesture is recognized by an incurvation of one finger while a different finger remains extended.

18. The method of claim 1, wherein the pattern of movement comprises a separation of a plurality of a user's fingers.

19. The method of claim 1, wherein the pattern of movement comprises movement of a finger in a diagonal path through the imaged space and the command comprises a resize command.

20. The method of claim 1, wherein the pattern of movement comprises a closed hand followed by opening of the hand.

21. The method of claim 20, wherein the hand is opened with a number of fingers and the command is based on the number of fingers.

22. The method of claim 1, wherein the pattern of movement comprises a plurality of fingers arranged as if gripping a knob.

23. The method of claim 1, wherein the pattern of movement comprises movement of a hand through the imaged space and the command comprises a panning command.

24. The method of claim 1, wherein the pattern of movement comprises closing of a hand followed by rotation of the closed hand.

25. A device, comprising:
a processor; and
an imaging device,
wherein the processor is configured by program code embodied in a computer-readable medium and comprising:
program code that configures the processor to determine whether a gesture recognition mode is activated;
program code that configures the processor to use image data from the imaging device to identify a pattern of movement of an object in the space; and
program code that configures the processor to execute a command corresponding to the identified pattern of movement if the gesture recognition mode is activated.

26. The device of claim 25, wherein the program instructions further comprise:
program code that configures the processor to analyze data from the imaging device to determine whether an object is in the space for a threshold period of time and, if the object is in the space for the threshold period of time, store data indicating that the gesture recognition mode is activated.

27. The device of claim 25, wherein the program code that configures the processor to analyze data from the imaging device configures the processor to analyze the data to determine whether a finger is in the space for a threshold period of time.

28. The device of claim 25, wherein identifying the pattern of movement of the object in the space comprises identifying a deactivation pattern and executing the command comprises storing data that the gesture recognition mode is no longer activated.

29. The device of claim 25, wherein program code that configures the processor to use image data from the imaging device to identify a pattern of movement of an object in the space configures the processor identify a path in space corresponding to an alphanumeric character.

30. A computer program product comprising a computer-readable medium embodying program code, the program code comprising:
program code for receiving input indicating that a gesture recognition mode of a computing device is to be activated;
program code for, in response to the received input, activating the gesture recognition mode; and
program code for, while the gesture recognition mode is activated:
obtaining image data representing a space,
identifying a pattern of movement of an object in the space based on the image data,
determining a command to be carried out by the computing device and corresponding to the command, and
carrying out the command.

31. The computer program product of claim 30, wherein receiving input indicating that the gesture recognition mode is to be activated comprises:
obtaining image data representing the space, and
analyzing the image data to determine whether the object is in the space for a threshold period of time, wherein the gesture recognition mode is to be activated if the object remains in view for the threshold period of time.

32. The computer program product of claim 30, wherein identifying the pattern of movement of the object in the space comprises identifying a deactivation pattern, wherein the command is a command to exit the gesture recognition mode, and wherein carrying out the command is exiting the gesture recognition mode.

33. The computer program product of claim 30,
wherein identifying the pattern of movement of the object comprises identifying a first pattern of movement followed by a second pattern of movement, and
wherein determining the command to be carried out comprises selecting one of a plurality of commands corresponding to the first pattern of movement and determining a parameter value based on the second pattern of movement.
